(19) United States
(12) Patent Application Publication
(10) Pub. No.: US 2019/0073752 A1
(43) Pub. Date: Mar. 7, 2019

(54) METHOD AND DEVICE FOR REMOVING SCANNING BED FROM CT IMAGE

(71) Applicant: SHENZHEN INSTITUTES OF ADVANCED TECHNOLOGY CHINESE ACADEMY OF SCIENCES, SHENZHEN (CN)

(72) Inventors: SHAODE YU, SHENZHEN (CN); LUMING CHEN, SHENZHEN (CN); ZHIHUA JI, SHENZHEN (CN); FAN JIANG, SHENZHEN (CN); SHIBIN WU, SHENZHEN (CN); YAOQIN XIE, SHENZHEN (CN); LEI WANG, SHENZHEN (CN)

(21) Appl. No.: 16/183,758

(22) Filed: Nov. 8, 2018

Related U.S. Application Data
(63) Continuation of application No. PCT/CN2016/087435, filed on Jun. 28, 2016.

(30) Foreign Application Priority Data
May 12, 2016 (CN) 201610319007.9

(51) Int. Cl. G06T 5/00; G06T 7/136; G06T 7/194; G06T 5/50

(52) U.S. Cl. CPC G06T 5/005; G06T 7/136; G06T 7/194; G06T 5/50; G06T 2207/30004; G06T 2207/20036; G06K 2209/05; G06T 2207/20212; G06T 2207/10081

(57) ABSTRACT

The application relates to a method and device for removing a scanning bed from a CT image. The method includes steps: reading a three-dimensional CT image, counting an amount of kernels in a CT apparatus and initializing sub-algorithms through a main thread of an image processing apparatus; extracting two-dimensional scanning images from the input three-dimensional CT image, automatically allocating the two-dimensional scanning images to kernels through the main thread of the image processing apparatus by sharing a memory, thereby realizing a multi-thread parallel processing to perform a bed removing operation on the two-dimensional scanning images; and ending the parallel processing and outputting a three-dimensional CT image without scanning bed information through the image processing apparatus. The method of the disclosure is very effective and accurate.

### FIELD OF THE DISCLOSURE

The disclosure relates to the field of image segmentation technologies, and more particularly to a method and a device for removing a scanning bed from a computed tomography (CT) image.

### BACKGROUND

With the development of advanced hardware, the spatial resolution of CT images is dramatically increased and the matrix size of a routine CT image reaches 512*512 which accounts for more than 250,000 pixels in a single slice. Moreover, if the gray value is stored in 8 bytes, the amount of data reaches 2 megabytes. As for a whole-body CT scanning, the number of slices is generally larger than 100. And subsequently, the data of a three-dimensional CT image exceeds 200 megabytes. The huge data amount to be processed and the limited number of algorithms for medical image segmentation affect the efficiency of clinical treatment. Thus accelerating image segmentation is the basis for the real-time clinical diagnosis.

The methods for accelerating image segmentation mainly include hardware-based acceleration and software-based acceleration. Hardware-based acceleration is to increase the speed of image segmentation by using a large memory, a large capacity, and multiple CPUs of high-configuration devices. Its drawbacks include: (1) hardware should be designed according to actual applications and thus, equipment costs are increased, maintenance costs are high and maintenance is difficult; (2) the acceleration effect is not obvious due to the limited existing segmentation algorithms. Software-based acceleration is derived from deep understanding of the principle of image segmentation algorithm, such as reducing the inner loop or downsampling preprocessed image, but its drawbacks include: (1) it needs to study the essence of the algorithm which is difficult and time-consuming to rewrite the code because of the complexity and diversity of the algorithm; (2) the acceleration might be limited, such as image preprocessing, gray scale statistics or multi-layer loops in the image segmentation process.

A CT scanning bed is used to cooperate with a scanning device to complete scanning. The scanning bed has the functions of moving up and down, front and rear, and the scanning bed is adjusted according to different scanning purposes. However, in practice, the CT image taken usually contains the image of the scanning bed. More severely, the image of the scanning bed might interfere with the CT image, which affects the accuracy of clinical diagnosis. Therefore, removing the CT scanning bed is the first step of CT image processing. Currently, algorithms for the removal of CT scanning bed are implemented in CT devices with built-in bed removing algorithms. Built-in algorithms are based on the model characteristics of the scanning bed in the device. However, these algorithms are not universal because of different manufacturers. In addition, the bed removing algorithm is not visible, and researchers and doctors cannot modify the algorithm according to actual needs. Furthermore, CT apparatus with built-in bed removing algorithms usually uses hardware-based acceleration or software-based acceleration, and the acceleration effect is not obvious.

### SUMMARY

The present invention provides a method and a device for removing a scanning bed from a CT image, to solve the technical problems that the built-in bed removing algorithm in the prior art is not universal, takes a long time, and has a bad effect.

In the disclosure, a method for removing a scanning bed from a CT image is provided. The method comprises: step a, reading a three-dimensional CT image as an input, counting an amount of kernels in a CT apparatus, and initializing sub-algorithms; step b, extracting two-dimensional, scanning images from the input three-dimensional CT image, automatically allocating the two-dimensional scanning images to kernels through the main thread of the image processing apparatus by sharing a memory, thereby realizing a multi-thread parallel processing to perform a bed removing operation on the two-dimensional scanning images; and step c, ending the parallel processing and outputting a three-dimensional CT image with scanning bed been removed.

In an embodiment, the step b comprises: step b1, extracting the two-dimensional scanning images from the input three-dimensional CT image, reading the two-dimensional scanning images, and performing segmentations on the read two-dimensional scanning images; step b₂, extracting image information of target areas in the read two-dimensional scanning images; step b3, performing morphological opening operations on the extracted image information of the target areas; step b4, acquiring image grayscale information of the target areas in the read two-dimensional scanning images; and step b5, combining the image grayscale information of the target areas in the read two-dimensional scanning image acquired by respective threads, and thereby removing scanning bed information.

In an embodiment, the step b1 comprises: performing an OTSU threshold segmentation on each of the read two-dimensional scanning images.

In an embodiment, in the step b2, extracting image information of target areas in the read two-dimensional scanning images comprises extracting information of body parts in the read two-dimensional scanning images.

In an embodiment, in the step b3, acquiring image grayscale information of the target areas in the read two-dimensional scanning images comprises: acquiring grayscale information of body parts in the read two-dimensional scanning images so as to remove the scanning bed information from the three-dimensional CT image.

A device for removing a scanning bed from a CT image is provided. The device comprises at least one processor device and at least one memory device coupled to the at least one processor device and stored with a plurality of modules executable by the at least one processor device. The plurality of modules comprises an image reading module, an image processing module, and an image output module. The image reading module is configured to read a three-dimensional CT image as an input, count an amount of kernels in a CT apparatus, and initialize sub-algorithms. The image processing module is configured to extract two-dimensional scanning images from the input three-dimensional CT image, and automatically allocate the two-dimensional scanning images to the kernels by sharing a memory, so as to realize a multi-thread parallel processing to perform a bed removing operation on the two-dimensional scanning images. The image output module is configured to end the parallel processing and output a three-dimensional CT image of the scanning bed been removed.

In an embodiment, the image processing module comprises an image segmentation sub-module, an image extracting sub-module, an image operation sub-module, an information acquiring sub-module, and an image combing sub-module; wherein the image segmentation sub-module is configured to read the two-dimensional scanning images, and perform segmentations on the read two-dimensional scanning images; wherein the image extracting sub-module is configured to extract image information of target areas in the two-dimensional scanning images; wherein the image operation sub-module is configured to perform morphological opening operations on the extracted image information of the target areas; wherein the information acquiring sub-module is configured to acquire image grayscale information of the target areas in the two-dimensional scanning images; wherein the image combining sub-module is configured to combine image grayscale information of the target areas in the two-dimensional scanning images acquired by respective threads, and thereby remove scanning bed information.

In an embodiment, the image segmentation sub-module is concretely configured to perform an OTSU threshold segmentation on each of the read two-dimensional scanning images.

In an embodiment, the image extracting sub-module is configured to extract image information of target areas in the two-dimensional scanning images concretely comprises: extract Information of body parts in the two-dimensional scanning images.

In an embodiment, the information acquiring sub-module is configured to acquire image grayscale information of the target areas in the two-dimensional scanning images comprises: acquire grayscale information of body parts in the two-dimensional scanning images to remove the scanning bed information from the three-dimensional CT image.

A device for removing a scanning bed from a CT image is provided. The device comprises at least one processor device and at least one memory device coupled to the at least one processor device, the at least one memory device storing program instructions for causing, when executed, the at least one processor device to perform: step a, reading a three-dimensional CT image as an input, counting an amount of kernels in a CT apparatus and initializing sub-algorithms; step b: extracting two-dimensional scanning images from the input three-dimensional CT image, automatically allocating the two-dimensional scanning images to the kernels by sharing a memory, and thereby realizing a multi-thread parallel processing to perform a bed removing operation on the two-dimensional scanning images; and step c: ending the parallel processing and outputting a three-dimensional CT image of the scanning bed been removed.

In an embodiment, the step b comprises: step b1: extracting the two-dimensional scanning images from the input three-dimensional CT image, reading the two-dimensional scanning images, and performing segmentations on the read two-dimensional scanning images; step b2: extracting image information of target areas in the read two-dimensional scanning images; step b3: performing morphological opening operations on the extracted image information of the target areas; step b4: acquiring image grayscale information of the target areas in the read two-dimensional scanning images; and step b5: combining the image grayscale information of the target areas in the read two-dimensional scanning image acquired by respective threads, and removing scanning bed information.

In an embodiment, the step b1 comprises: performing an OTSU threshold segmentation on each of the read two-dimensional scanning images.

In an embodiment, in the step b2, extracting image information of target areas in the read two-dimensional scanning images comprises extracting information of body parts in the read two-dimensional scanning images.

In an embodiment, in the step b3, acquiring image grayscale information of the target areas in the read two-dimensional scanning images comprises: acquiring grayscale information of body parts in the read two-dimensional scanning images so as to remove the scanning bed information from the three-dimensional CT image.

The image segmentation algorithm adopted in the method and device for removing scanning bed from a CT image of the present disclosure is very, effective and accurate, and the body mask information is not lost while the scanning bed information is removed. In addition, the method and device of the present disclosure significantly increases the removing speed to the scanning bed and meets the real-time requirements.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the drawings:

FIG. 1 is a flow chart of a method for removing a scanning bed form a CT image, according to an embodiment of the present disclosure;

FIG. 2 is a flow chart of performing a bed removing operation on two-dimensional scanning images, in a method for removing a scanning bed form a CT image, according to an embodiment of the present disclosure;

FIG. 3 is a flow chart of a method for removing a scanning bed form a CT image, according to another embodiment of the present disclosure;

FIG. 4 is a schematic structural view of a device for removing a scanning bed form a CT Image, according to an embodiment of the present disclosure;

FIG. 5 is a diagram showing experimental results of a method for removing a scanning bed form a CT image, according to an embodiment of the present disclosure;

FIG. 6 is a diagram showing accuracy of three-dimensional data segmentation of a method for removing a scanning bed form a CT image, according to an embodiment of the present disclosure.

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

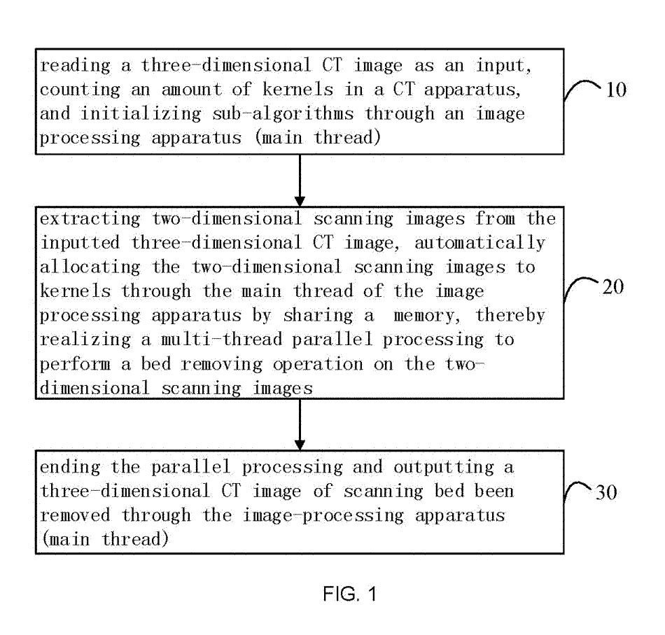

Referring to FIG. 1, FIG. 1 is a flow chart of a method for removing a scanning bed form a CT image, according to an embodiment of the present disclosure. The method for removing a scanning bed form a CT image of the present embodiment includes the following steps.

Step 10: reading a three-dimensional CT image as an input, counting an amount of kernels in a CT apparatus, and initializing sub-algorithms through a main thread of an image processing apparatus.

In the step 10, the image processing apparatus for reading a three-dimensional CT image can be disposed in the CT apparatus, can be disposed outside of the CT apparatus, or be disposed independent from the CT apparatus.

Step 20: extracting two-dimensional scanning images from the input three-dimensional CT image, automatically allocating the two-dimensional scanning images to the kernels through the main thread of the image processing apparatus by sharing a memory, so as to realizing a multi-thread parallel processing to perform a bed removing operation on the two-dimensional scanning images.

Step 30: ending the parallel processing and outputting a three-dimensional CT image of the scanning bed been removed through the image processing apparatus.

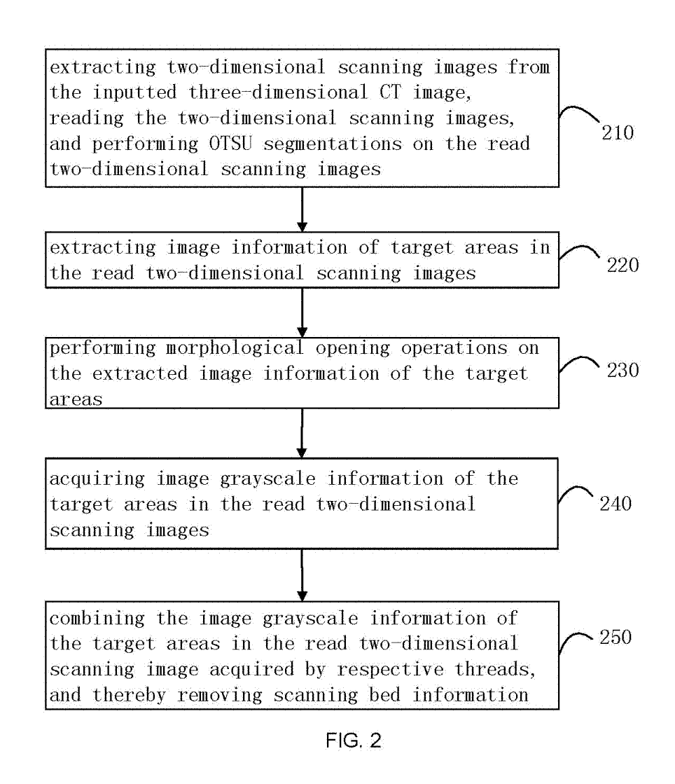

Referring to FIG. 2, FIG. 2 is a flow chart of performing a bed removing operation on two-dimensional scanning images, in a method for removing a scanning bed from a CT image, according to an embodiment of the present disclosure. The bed removing operation of the present embodiment specifically includes the following steps.

Step 210: extracting two-dimensional scanning images from the input three-dimensional CT image, reading the two-dimensional scanning images, and then performing OTSU threshold segmentations on the read two-dimensional scanning images.

In the step 210, OTSU threshold segmentations are performed on the read two-dimensional scanning images according to a principle of bed removing algorithm. The OTSU threshold segmentation divides the image into two parts, the background and the target, according to the grayscale characteristics of the image. The larger the between-class variance between the background and the target, the greater the difference between the two parts that constitute the image. When a portion of the target is divided into the background or a portion of the background is divided into the target, the difference between the two parts will be smaller. Therefore, the segmentation that maximizes the between-class variance means that the probability of misclassification is minimal.

Step 220: extracting image information of target areas in the two-dimensional scanning images.

In the step 220, extracting image information of target areas in the two-dimensional scanning images includes extracting image information of body parts in the two-dimensional scanning images.

Step 230: performing morphological opening operations on the extracted image information of target areas.

In step 230, morphology is mainly to obtain topological and structural information of an object, and obtain some more essential forms of the object through some operations of interaction between the object and a structural element. The application in image processing is mainly to use the basic operations of morphology to observe and process images to achieve the purpose of improving image quality. Erosion and dilation of image morphology can well denoise a binary image. The specific operation of erosion is: scanning each pixel in the image with a structural element (generally 3×3 size), and using each pixel in the structural element to perform an “AND” (&&) operation on the pixel it covers, if both are 1, then the pixel is 1, otherwise it is 0. The specific operation of the dilation is: scanning each pixel in the image with a structural element (generally 3×3 size), and performing an “AND” (&&) operation on each pixel of the structural element with the pixel it covers, if both are 0, then the pixel is 0, otherwise it is 1. The function of erosion is to eliminate boundary points of the object, reduce the target, and eliminate noise points smaller than the structural elements. The effect of dilation is to merge all the background points that are in contact with the object into the object, increase the target and fill the holes, in the target. Opening operation is a process of first erosion and then dilation, which can eliminate fine noise on the image and smooth the boundary of the object.

Step 240: acquiring grayscale information of the target areas in the two-dimensional scanning images.

In step 240, acquiring grayscale information of the target areas in the two-dimensional scanning images is: acquiring grayscale information of the body parts in the two-dimensional scanning images so as to remove scanning bed information from the three-dimensional CT image.

Step 250: combining the grayscale information of the target areas in the two-dimensional scanning images acquired by respective threads, and outputting a three-dimensional CT scanning image without scanning bed information.

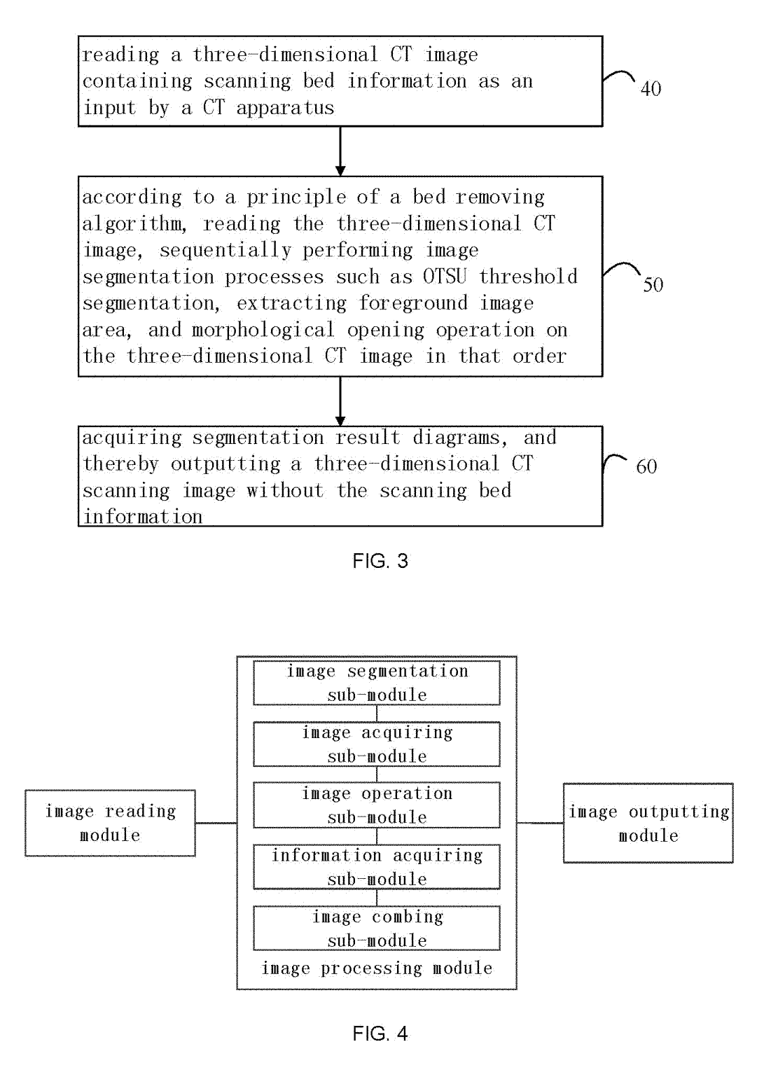

Referring to FIG. 3, FIG. 3 is a flow chart of a method for removing a scanning bed from a CT image, according to another embodiment of the present disclosure. The method of the present disclosure can be applied to a parallel CT scanning bed, also can be applied to a non-parallel CT scanning bed. If it is applied, to a hon-parallel CT scanning bed, then the method specifically includes the following steps.

Step 40: reading a three-dimensional CT image containing scanning bed information as an input by a CT apparatus.

Step 50: according to a principle of a bed removing algorithm, reading the three-dimensional CT image, sequentially performing image segmentation processes such as OTSU threshold segmentation, extracting foreground image area (including body part and scanning bed in CT images), and morphological opening operation on the three-dimensional CT image in that order.

The OTSU threshold segmentation divides the image into two parts, the background and the target, according to the grayscale characteristics of the image. The larger the between-class variance between the background and the target, the greater the difference between the two parts that constitute the image. When a portion of the target is divided into the background or a portion of the background is divided into the target, the difference between the two parts will be smaller. Therefore, the segmentation that maximizes the between-class variance means that the probability of misclassification is minimal. Morphology is mainly to obtain topological and structural information of an object, and obtains some more essential forms of the object through some operations of interaction between the object and a structural element. The application in image processing is mainly to use the basic operations of morphology to observe and process images to achieve the purpose of improving image quality. Erosion and dilation of image morphology can well denoise a binary image. The specific operation of erosion is: scanning each pixel in the image with a structural element (generally 3×3 size), and using each pixel in the structural element to perform an “AND” (&&) operation on the pixel it covers, if both are 1, then the pixel is 1, otherwise it is 0. The specific operation of the dilation is: scanning each pixel in the image with a structural element (generally 3×3 size), and performing an “AND” (&&) operation on each pixel of the structural element with the pixel it covers, if both are 0, then the pixel is 0, otherwise it is 1. The function of erosion is to eliminate boundary points of the object, reduce the target, and eliminate noise points smaller than the structural elements. The effect of dilation is to merge all the background points that are in contact with the object into the object, increase the target and fill the holes in the target. Opening operation is a process of first erosion and then dilation, which can eliminate fine noise on the image and smooth the boundary of the object.

Step 60: acquiring segmentation result diagrams, and thereby outputting a three-dimensional CT scanning image without the scanning bed information.

Referring to FIG. 4, FIG. 4 is a structural schematic view of a device for removing a scanning bed from a CT image, according to an embodiment of the present disclosure. The device of the present disclosure includes at least one processor device and at least one memory device coupled to the at least one processor device and stored with a plurality of modules executed by the at least one processor device. The plurality of modules includes an image reading module, an image processing module, and an image output module. The image reading module reads a three-dimensional CT image as an input, counts a amount of kernels in a CT apparatus, and initializes sub-algorithms. The image processing module extracts two-dimensional scanning images from the input three-dimensional CT image, automatically allocates the two-dimensional scanning images to kernels by sharing a memory, so as to realize a multi-thread parallel processing to perform a bed removing operation on the two-dimensional scanning images. The image output module ends the parallel processing and outputs a three-dimensional CT image of the scanning bed been removed. The image processing module includes an image segmentation sub-module, an image extracting sub-module, an image operation sub-module, an information acquiring sub-module, and an image combing sub-module. The image segmentation sub-module reads the two-dimensional scanning images, and performs OTSU threshold segmentations on the read two-dimensional scanning images. The image segmentation sub-module performs the OTSU threshold segmentations on the read two-dimensional scanning images according to a principle of a bed removing algorithm. The OTSU threshold segmentation divides the image into two parts, the background and the target, according to the grayscale characteristics of the image. The larger the between-class variance between the background and the target, the greater the difference between the two parts that constitute the image. When a portion of the target is divided into the background or a portion of the background is divided into the target, the difference between the two parts will be smaller. Therefore, the segmentation that maximizes the between-class variance means that the probability of misclassification is minimal.

The image extracting sub-module extracts image information of target areas in the two-dimensional scanning images, the manner of extracting image information of the target areas in the two-dimensional scanning images includes extracting information of body parts in the two-dimensional scanning images.

The image operation sub-module performs morphological opening operations on the extracted image information of target areas. Morphology is mainly to obtain topological and structural information of an object, and obtain some more essential forms of the object through some operations of interaction between the object and a structural element. The application in image processing is mainly to use the basic operations of morphology to observe and process images to achieve the purpose of improving image quality. Erosion and dilation of image morphology can well denoise the binary image. The specific operation of erosion is: scanning each pixel in the image with a structural element (generally 3×3 size), and using each pixel in the structural element to perform an “AND” (&&) operation on the pixel it covers, if both are 1, then the pixel is 1, otherwise it is 0. The specific operation of the dilation is: scanning each pixel in the image with a structural element (generally 3×3 size), and performing an “AND” operation on each pixel of the structural element with the pixel it covers, if both are 0, then the pixel is 0, otherwise it is 1. The function of erosion is to eliminate boundary points of the object, reduce the target, and eliminate noise points smaller than the structural elements. The effect of dilation is to merge all the background points that are in contact with the object into the object, increase the target and fill the holes in the target. Opening operation is a process of first erosion and then dilation, which can eliminate fine noise on the image and smooth the boundary of the object.

The image acquiring sub-module acquires image grayscale information of the target areas in the two-dimensional scanning images. The image acquiring sub-module acquires image grayscale information of the body parts in the two-dimensional scanning images, so as to remove scanning bed information therefrom.

The image combing sub-module combines the image grayscale information of the target areas in the two-dimensional scanning images acquired by respective threads, thereby forming a three-dimensional CT image without the scanning bed information.

The method of the present disclosure is verified by clinical experiments as follows. It can be understood that the clinical experiment verification is used to further illustrate the beneficial effects of the present disclosure; there is no restriction on the embodiments and scope of the protection for the disclosure.

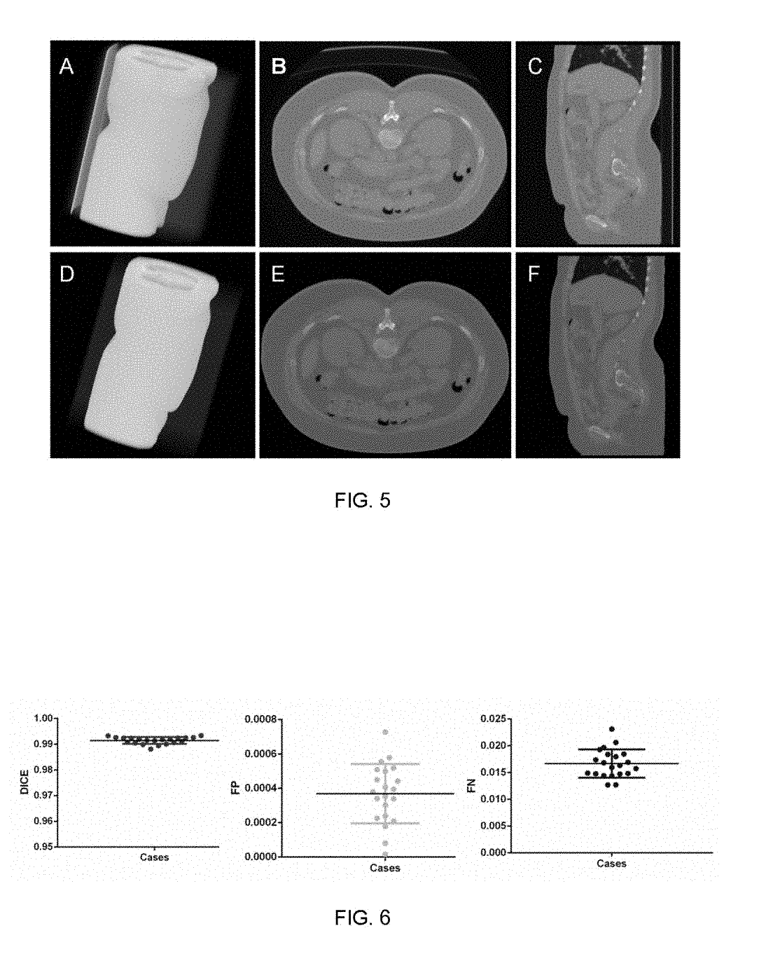

Referring to FIG. 5, FIG. 5 is a diagram showing experimental results of a method for removing a scanning bed from a CT image, according to an embodiment of the present disclosure. The first line of FIG. 5 provides original CT images with scanning bed, wherein (A) is a three-dimensional image in which a thin plate on a left side of a body can be clearly seen, (B) is a axial tangential image in which the scanning bed approximately looks like two curved curves, and (C) is a sagittal image in which the scanning bed is approximately a vertical line substantially parallel to the body. The second line of FIG. 5 shows the final images after bed removing operation by the algorithm of the present disclosure. Visually, the scanning bed removing program proposed by the present disclosure can remove the scanning bed image well, and there is almost no mistake erosion phenomenon occurred.

Average consumption time of each slice image is calculated as the following formula:

$$TC = \frac{I}{n} {\sum }_{i = 1}^{n} {tc}_{i} ,$$

where tcᵢ refers to the segmentation time required for the i-th slice image.

The calculation formula of the image segmentation accuracy parameter is as follows:

$$Dice = 2 \times \frac{\vert G ⋂ S \vert}{\vert G \vert + \vert S \vert} .$$

The image segmentation error rate parameter is expressed as follows:

False positive (FP) refers to the error rate of the algorithm proposed by the present disclosure fails to remove the scanning bed,

$$FP = \frac{\vert S \vert - \vert G ⋂ S \vert}{\vert G \vert} ;$$

False negative (FN) refers to the rate of false erosion of the body mask by the algorithm proposed by the present disclosure,

$$FN = \frac{\vert G \vert - \vert G ⋂ S \vert}{\vert G \vert} ,$$

where |·| is used to count number of points in the three-dimensional data, G refers to the bold standard for manual segmentation, and S refers to the segmentation result.

Referring to FIG. 6, FIG. 6 is a diagram showing accuracy of three-dimensional data segmentation of a method for removing a scanning bed from a CT image, according to an embodiment of the present disclosure. Overall, the average accuracy of the segmentation reaches 99%. The segmentation algorithm of the method of the present disclosure is very effective and accurate; the average values of the false positive and the false negative are 0.4% and 1.63%, respectively. It indicates that the bed removing algorithm of the present disclosure can accurately remove the scanning bed information there away and hardly damage the body mask.

The method for removing scanning bed from CT image of the present disclosure is implemented by software as Visual Studio 2010 and ITK, and is accelerated by using OpenMP. The experimental machine is 8-core Intel Cores™ with a clock speed of 3.7 GHz and a memory of 1 6G. It is noted that the method of the present disclosure also can be implemented by other hardware and software. For example, the method is implemented on at least one device, which has at least one processor and at least one storage coupled to the at least one processor and stored with a plurality of modules executable by the at least one processor.

| | | Not introducing | Introducing this |
|---|---|---|---|
| | Manual | this acceleration | acceleration |
| | segmentation | strategy | strategy |
| Time consumption | 124.51 | 0.79 | 0.29 |
| (s) | | | |
| Acceleration rate | 429.34 | 2.72 | 1.0 |
| (times) | | | |

The above bed compares the manual segmentation time, segmentation running time without this acceleration strategy, and time consumption introducing this acceleration strategy. By analyzing, it is found that the method of the present disclosure can perform a bed removing operation on an image with a resolution of [512, 512] in 0.29 seconds, and the speed of the bed removing operation is 2.72 times that of unaccelerated. The method of the present disclosure greatly improves the removing speed of the scanning bed in the method and meets the real-time requirement.

The image segmentation algorithm adopted, in the method and device for removing scanning bed from a CT image of the present disclosure is very effective and accurate, and the body mask information is not lost while the scanning bed information is removed. In addition, the method and device of the present disclosure significantly increases the removing speed to the scanning bed and meets the real-time requirements.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A method for removing a scanning bed from a computed tomography (CT) image, comprising:
step a: reading a three-dimensional CT image as an input, counting an amount of kernels in a CT apparatus and initializing sub-algorithms through a main thread of an image processing apparatus;
step b: extracting two-dimensional scanning images from the input three-dimensional CT image through the main thread of the image processing apparatus, automatically allocating the two-dimensional scanning images to the kernels through the image processing apparatus by sharing a memory, and thereby realizing a multi-thread parallel processing to perform a bed removing operation on the two-dimensional scanning images; and
step c: ending the parallel processing and outputting three-dimensional CT image of the scanning bed been removed through the image processing apparatus.

2. The method according to claim 1, wherein the step b comprises:
step b1: extracting the two-dimensional scanning images from the input three-dimensional CT image, reading the two-dimensional scanning images, and performing segmentations on the read two-dimensional scanning images;
step b2: extracting image information of target areas In the read two-dimensional scanning images;
step b3: performing morphological opening operations on the extracted image information of the target areas;
step b4: acquiring image grayscale information of the target areas in the read two-dimensional scanning images; and
step b5: combining the image grayscale information of the target areas in the read two-dimensional scanning image acquired by respective threads, and thereby removing scanning bed information.

3. The method according to claim 2, wherein the step b1 comprises:
performing an OTSU threshold segmentation on each of the read two-dimensional scanning images.

4. The method according to claim 2, wherein in the step b2, extracting image information of target areas in the read two-dimensional scanning images comprises extracting information of body parts in the read two-dimensional scanning images.

5. The method according to claim 2, wherein in the step b3, acquiring image grayscale information of the target areas in the read two-dimensional scanning images comprises:
acquiring grayscale information of body parts in the read two-dimensional scanning images so as to remove the scanning bed information from the three-dimensional CT image.

6. A device for removing a scanning bed from a CT image, comprising:
at least one processor device and at least one memory device coupled to the at least one processor device and stored with a plurality of modules executable by the at least one processor device; wherein the plurality of modules comprises an image reading module, an image processing module, and an image output module;
wherein the image reading module is configured to read a three-dimensional CT image as an input, count an amount of kernels in a CT apparatus, and initialize sub-algorithms;
wherein the image processing module is configured to extract two-dimensional scanning images from the Input three-dimensional CT image, and automatically allocate the two-dimensional scanning images to the kernels by sharing a memory, so as to realize a multi-thread parallel processing to perform a bed removing operation on the two-dimensional scanning images;
wherein the image output module is configured to end the parallel processing and output a three-dimensional CT image with the scanning bed been removed.

7. The device according to claim 6, wherein the image processing module comprises an image segmentation sub-module, an image extracting sub-module, an image operation sub-module, an information acquiring sub-module, and an image combing sub-module;
wherein the image segmentation sub-module is configured to read the two-dimensional scanning images, and perform segmentations on the read two-dimensional scanning images;
wherein the image extracting sub-module is configured to extract image information of target areas in the two-dimensional scanning images;
wherein the image operation sub-module is configured to perform morphological opening operations on the extracted image information of the target areas;
wherein the information acquiring sub-module is configured to acquire image grayscale information of the target areas in the two-dimensional scanning images;
wherein the image combining sub-module is configured to combine image grayscale information of the target areas in the two-dimensional scanning images acquired by respective threads, and thereby remove scanning bed information.

8. The device according to claim 7, wherein the image segmentation sub-module is concretely configured to perform an OTSU threshold segmentation on each of the read two-dimensional scanning images.

9. The device according to claim 7, wherein the image extracting sub-module is configured to extract image information of target areas in the two-dimensional scanning images concretely comprises: extract information of body parts in the two-dimensional scanning images.

10. The device according to claim 8, wherein the image extracting sub-module is configured to extract image information of target areas in the two-dimensional scanning images concretely comprises: extract information of body parts in the two-dimensional scanning images.

11. The device according to claim 7, wherein the information acquiring sub-module is configured to acquire image grayscale information of the target areas in the two-dimensional scanning images comprises: acquire grayscale information of body parts in the two-dimensional scanning images to remove the scanning bed information from the three-dimensional CT image.

12. The device according to claim 8, wherein the information acquiring sub-module is configured to acquire image grayscale information of the target areas in the two-dimensional scanning images comprises: acquire grayscale information of body parts in the two-dimensional scanning images to remove the scanning bed information from the three-dimensional CT image.

13. A device for removing a scanning bed from a CT image, comprising at least one processor device and at least one memory device coupled to the at least one processor device, the at least one memory device storing program instructions for causing, when executed, the at least one processor device to perform:
step a, reading a three-dimensional CT image as an input, counting an amount of kernels in a CT apparatus and initializing sub-algorithms;
step b: extracting two-dimensional scanning images from the input three-dimensional CT image, automatically allocating the two-dimensional scanning images to the kernels by sharing a memory, and thereby realizing a multi-thread parallel processing to perform a bed removing operation on the two-dimensional scanning images; and
step c: ending the parallel processing and outputting a three-dimensional CT image of the scanning bed been removed.

14. The device according to claim 13, wherein the step b comprises:
step b1: extracting the two-dimensional scanning images from the input three-dimensional CT image, reading the two-dimensional scanning images, and performing segmentations on the read two-dimensional scanning images;
step b2: extracting image information of target areas in the read two-dimensional scanning images;
step b3: performing morphological opening operations on the extracted image information of the target areas;
step b4: acquiring image grayscale information of the target areas in the read two-dimensional scanning images; and
step b5: combining the image grayscale information of the target areas in the read two-dimensional scanning image acquired by respective threads, and removing scanning bed information.

15. The device according to claim 14, wherein the step b1 comprises:
performing an OTSU threshold segmentation on each of the read two-dimensional scanning images.

16. The device according to claim 14, wherein in the step b2, extracting image information of target areas in the read two-dimensional scanning images comprises extracting information of body parts in the read two-dimensional scanning images.

17. The device according, to claim 14, wherein in the step b3, acquiring image grayscale information of the target areas in the read two-dimensional scanning images comprises:
acquiring grayscale information of body parts in the read two-dimensional scanning images so as to remove the scanning bed information from the three-dimensional CT image.
